(19) United States
(12) Patent Application Publication
(10) Pub. No.: US 2013/0346256 A1
(43) Pub. Date: Dec. 26, 2013

(54) METHODS AND SYSTEMS FOR PROVIDING INFORMATION RELATING TO ITEMS DISPLAYED IN AUDIOVISUAL WORKS

(71) Applicants: Dyana Canavan, Stevenson, WA (US); Kristy Surovic, Vancouver, WA (US)

(72) Inventors: Dyana Canavan, Stevenson, WA (US); Kristy Surovic, Vancouver, WA (US)

(21) Appl. No.: 13/925,594

(22) Filed: Jun. 24, 2013

Related U.S. Application Data
(60) Provisional application No. 61/663,038, filed on Jun. 22, 2012.

(51) Int. Cl. H04L 29/06; G06Q 20/12

(52) U.S. Cl. CPC H04L 65/40; G06Q 20/123
USPC 705/27.1; 709/217

(57) ABSTRACT

Systems and methods for providing information relating to items displayed in audiovisual works. Some examples include recording a signal associated with an audiovisual work displaying an item, communicating the signal to a media link server, receiving, on the listening device, media link data from the media link server in response to communicating the communicated signal, the media link data including item data associated with the item and timing data specifying at least a portion of the audiovisual work, and displaying at least a portion of the item data on the display of the listening device when a current playback position of the audiovisual work is within the portion of the audiovisual work specified by the timing data. Some examples include receiving a signal identifying an audiovisual work, processing the signal to identify the audiovisual work, and sending media link data associated with an item displayed in the audiovisual work.

### CROSS REFERENCE TO RELATED APPLICATIONS

This application claims priority to copending U.S. Provisional Application Ser. No. 61/663,038, filed on Jun. 22, 2012, which is hereby incorporated by reference for all purposes.

### BACKGROUND

The present disclosure relates generally to methods and systems for providing information relating to items displayed in audiovisual works. In particular, this disclosure relates to methods that display information about items on listening devices as a user watches an audiovisual work.

When watching audiovisual works, such as movies or television programs, viewers often see items that interest them but are not specifically identified in the work. For example, a viewer may see an enticing piece of jewelry worn by an actress or an interesting work of art displayed in the background. Currently, there is no satisfactory way for a viewer to identify such items. In such circumstances, viewers are required to independently research the item and hope they can properly identify it.

This method is problematic. First, it is often difficult to properly identify items seen in audiovisual works. For example, certain items may be rare or only typically offered by distant retailers. Additionally or alternatively, it may be difficult to distinguish the viewed item from other similar items. Even when a viewer does successfully identify the viewed item, the process is often frustrating and time consuming.

Some producers of audiovisual works have approached this problem by displaying item data directly within the audiovisual work. This is an imperfect solution, as it may significantly hinder the work's artistic merit. Further, this solution would be impractical unless producers decide to display item data in the original versions of their works.

Thus, there exists a need for methods and systems that provide information about items displayed in audiovisual works that reduce the need to research the work or introduce unsightly displays into the work. Indeed, there exists a need for methods and systems that provide viewers with item data provided by the producers and retailers of displayed items (or others who have already independently researched and identified displayed items). Examples of such methods and systems that are relevant to the needs existing in the field are discussed below.

### SUMMARY

The present disclosure is directed to systems and methods for providing information relating to items displayed in audiovisual works. Some examples include recording a signal associated with an audiovisual work displaying an item, communicating the signal to a media link server, receiving, on the listening device, media link data from the media link server in response to communicating the communicated signal, the media link data including item data associated with the item and timing data specifying at least a portion of the audiovisual work, and displaying at least a portion of the item data on the display of the listening device when a current playback position of the audiovisual work is within the portion of the audiovisual work specified by the timing data.

Some examples include receiving a signal identifying an audiovisual work, processing the signal to identify the audiovisual work, and sending media link data associated with an item displayed in the audiovisual work.

Some examples may include a computer readable medium including processor executable instructions for performing some or all of the disclosed steps.

### BRIEF DESCRIPTION OF THE DRAWINGS

FIG. 1 shows a schematic view of an example of a programmable computing device.

FIG. 2 shows a schematic view of an example of a mobile electronic device.

FIG. 3 shows a diagrammatic view of a media link server and a listening device in data communication with one another.

FIG. 4 shows a table illustrating example media link data.

FIG. 5 is a schematic of an example use of the disclosed methods.

FIG. 6 is a schematic of an additional or alternative example use of the disclosed methods.

FIG. 7 is a flow diagram of a first example of a method for providing information relating to an item displayed in an audiovisual work.

FIG. 8 is a flow diagram of a second example of a method for providing information relating to an item displayed in an audiovisual work.

FIG. 9 is a schematic of an additional or alternative use of the disclosed methods.

### DETAILED DESCRIPTION

The disclosed methods and systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various methods and systems are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

Various disclosed examples may be implemented using electronic circuitry configured to perform one or more functions. For example, with some embodiments of the invention, the disclosed examples may be implemented using one or more application-specific integrated circuits (ASICs). More typically, however, components of various examples of the invention will be implemented using a programmable computing device executing firmware or software instructions, or by some combination of purpose-specific electronic circuitry and firmware or software instructions executing on a programmable computing device.

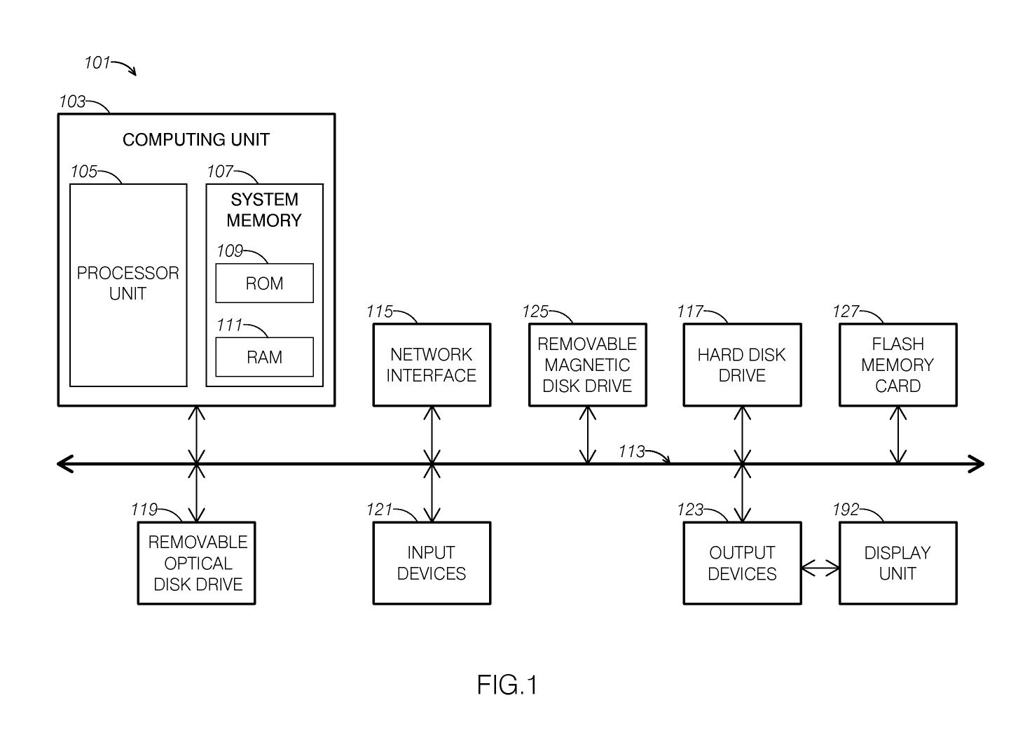

Accordingly, FIG. 1 shows one illustrative example of a computer, computer 101, which can be used to implement various embodiments of the invention. Computer 101 may be incorporated within a variety of consumer electronic devices, such as personal media players, cellular phones, smart phones, personal data assistants, global positioning system devices, and the like.

As seen in this figure, computer 101 has a computing unit 103. Computing unit 103 typically includes a processing unit 105 and a system memory 107. Processing unit 105 may be any type of processing device for executing software instructions, but will conventionally be a microprocessor device. System memory 107 may include both a read-only memory (ROM) 109 and a random access memory (RAM) 111. As will be appreciated by those of ordinary skill in the art, both read-only memory (ROM) 109 and random access memory (RAM) 111 may store software instructions to be executed by processing unit 105.

Processing unit 105 and system memory 107 are connected, either directly or indirectly, through a bus 113 or alternate communication structure to one or more peripheral devices. For example, processing unit 105 or system memory 107 may be directly or indirectly connected to additional memory storage, such as a hard disk drive 117, a removable optical disk drive 119, a removable magnetic disk drive 125, and a flash memory card 127. Processing unit 105 and system memory 107 also may be directly or indirectly connected to one or more input devices 121 and one or more output devices 123. Input devices 121 may include, for example, a keyboard, touch screen, a remote control pad, a pointing device (such as a mouse, touchpad, stylus, trackball, or joystick), a scanner, a camera or a microphone. Output devices 123 may include, for example, a monitor display, an integrated display, television, printer, stereo, or speakers.

Still further, computing unit 103 will be directly or indirectly connected to one or more network interfaces 115 for communicating with a network. This type of network interface 115 is also sometimes referred to as a network adapter or network interface card (NIC). Network interface 115 translates data and control signals from computing unit 103 into network messages according to one or more communication protocols, such as the Transmission Control Protocol (TCP), the Internet Protocol (IP), and the User Datagram Protocol (UDP). These protocols are well known in the art, and thus will not be discussed here in more detail. An interface 115 may employ any suitable connection agent for connecting to a network, including, for example, a wireless transceiver, a power line adapter, a modem, or an Ethernet connection.

It should be appreciated that, in addition to the input, output and storage peripheral devices specifically listed above, the computing device may be connected to a variety of other peripheral devices, including some that may perform input, output and storage functions, or some combination thereof. For example, the computer 101 may be connected to a digital music player, such as an IPOD® brand digital music player or iOS or Android based smartphone. As known in the art, this type of digital music player can serve as both an output device for a computer (e.g., outputting music from a sound file or pictures from an image file) and a storage device.

In addition to a digital music player, computer 101 may be connected to or otherwise include one or more other peripheral devices, such as a telephone. The telephone may be, for example, a wireless “smart phone,” such as those featuring the Android or iOS operating systems. As known in the art, this type of telephone communicates through a wireless network using radio frequency transmissions. In addition to simple communication functionality, a “smart phone” may also provide a user with one or more data management functions, such as sending, receiving and viewing electronic messages (e.g., electronic mail messages, SMS text messages, etc.), recording or playing back sound files, recording or playing back image files (e.g., still picture or moving video image files), viewing and editing files with text (e.g., Microsoft Word or Excel files, or Adobe Acrobat files), etc. Because of the data management capability of this type of telephone, a user may connect the telephone with computer 101 so that their data maintained may be synchronized.

Of course, still other peripheral devices may be included with or otherwise connected to a computer 101 of the type illustrated in FIG. 1, as is well known in the art. In some cases, a peripheral device may be permanently or semi-permanently connected to computing unit 103. For example, with many computers, computing unit 103, hard disk drive 117, removable optical disk drive 119 and a display are semi-permanently encased in a single housing.

Still other peripheral devices may be removably connected to computer 101, however. Computer 101 may include, for example, one or more communication ports through which a peripheral device can be connected to computing unit 103 (either directly or indirectly through bus 113). These communication ports may thus include a parallel bus port or a serial bus port, such as a serial bus port using the Universal Serial Bus (USB) standard or the IEEE 1394 High Speed Serial Bus standard (e.g., a Firewire port). Alternately or additionally, computer 101 may include a wireless data “port,” such as a Bluetooth® interface, a Wi-Fi interface, an infrared data port, or the like.

It should be appreciated that a computing device employed according to the various examples of the invention may include more components than computer 101 illustrated in FIG. 1, fewer components than computer 101, or a different combination of components than computer 101. Some implementations of the invention, for example, may employ one or more computing devices that are intended to have a very specific functionality, such as a digital music player or server computer. These computing devices may thus omit unnecessary peripherals, such as the network interface 115, removable optical disk drive 119, printers, scanners, external hard drives, etc. Some implementations of the invention may alternately or additionally employ computing devices that are intended to be capable of a wide variety of functions, such as a desktop or laptop personal computer. These computing devices may have any combination of peripheral devices or additional components as desired.

In many examples, computers may define mobile electronic devices, such as smartphones, tablet computers, or portable music players, often operating the iOS, Symbian, Windows-based (including Windows Mobile and Windows 8), or Android operating systems.

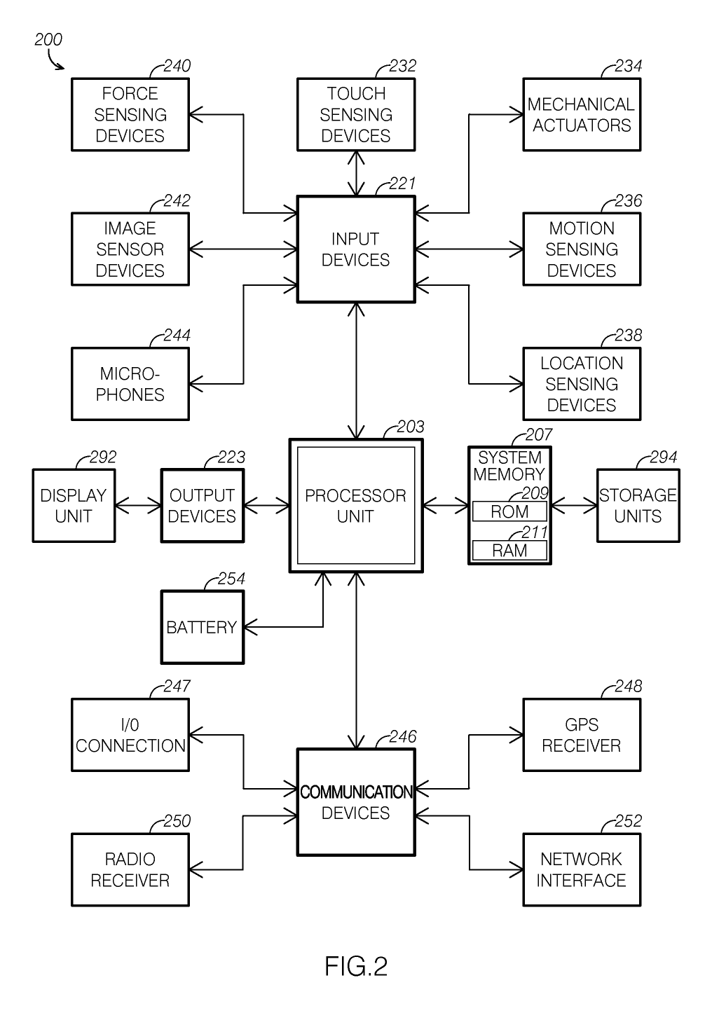

With reference to FIG. 2, an exemplary mobile device, mobile device 200, may include a processor unit 203 (e.g., CPU) configured to execute instructions and to carry out operations associated with the mobile device. For example, using instructions retrieved from memory, the controller may control the reception and manipulation of input and output data between components of the mobile device. The controller can be implemented on a single chip, multiple chips or multiple electrical components. For example, various architectures can be used for the controller, including dedicated or embedded processor, single purpose processor, controller, ASIC, etc. By way of example, the controller may include microprocessors, DSP, A/D converters, D/A converters, compression, decompression, etc.

In most cases, the controller together with an operating system operates to execute computer code and produce and use data. The operating system may correspond to well known operating systems such as iOS, Symbian, Windows-based (including those directed to personal computer and mobile devices), or Android operating systems, or alternatively to special purpose operating system, such as those used for limited purpose appliance-type devices. The operating system, other computer code and data may reside within a system memory 207 that is operatively coupled to the controller. System memory 207 generally provides a place to store computer code and data that are used by the mobile device. By way of example, system memory 207 may include read-only memory (ROM) 209, random-access memory (RAM) 211, etc. Further, system memory 207 may retrieve data from storage units 294, which may include a hard disk drive, flash memory, etc. In conjunction with system memory 207, storage units 294 may include a removable storage device such as an optical disc player that receives and plays DVDs, or card slots for receiving mediums such as memory cards (or memory sticks).

Mobile device 200 also includes input devices 221 that are operatively coupled to processor unit 203. Input devices 221 are configured to transfer data from the outside world into mobile device 200. As shown, input devices 221 may correspond to both data entry mechanisms and data capture mechanisms. In particular, input devices 221 may include the following: touch sensing devices 232 such as touch screens, touch pads and touch sensing surfaces; mechanical actuators 234 such as button or wheels or hold switches; motion sensing devices 236 such as accelerometers; location detecting devices 238 such as global positioning satellite receivers, WiFi based location detection functionality, or cellular radio based location detection functionality; force sensing devices such as force sensitive displays and housings; image sensors; and microphones. Input devices 221 may also include a clickable display actuator.

Mobile device 200 also includes various output devices 223 that are operatively coupled to processor unit 203. Output devices 223 are configured to transfer data from mobile device 200 to the outside world. Output devices 223 may include a display unit 292 such as an LCD, speakers or jacks, audio/tactile feedback devices, light indicators, and the like.

Mobile device 200 also includes various communication devices 246 that are operatively coupled to the controller. Communication devices 246 may, for example, include both an I/O connection 247 that may be wired or wirelessly connected to selected devices such as through IR, USB, or Firewire protocols, a global positioning satellite receiver 248, and a radio receiver 250 which may be configured to communicate over wireless phone and data connections. Communication devices 246 may also include a network interface 252 configured to communicate with a computer network through various means which may include wireless connectivity to a local wireless network, a wireless data connection to a cellular data network, a wired connection to a local or wide area computer network, or other suitable means for transmitting data over a computer network.

Mobile device 200 also includes a battery 254 and possibly a charging system. Battery 254 may be charged through a transformer and power cord or through a host device or through a docking station. In the cases of the docking station, the charging may be transmitted through electrical ports or possibly through an inductance charging means that does not require a physical electrical connection to be made.

The various aspects, features, embodiments or implementations of the invention described above can be used alone or in various combinations. The methods of this invention can be implemented by software, hardware or a combination of hardware and software. The invention can also be embodied as computer readable code on a computer readable medium. The computer readable medium is any data storage device that can store data which can thereafter be read by a computer system, including both transfer and non-transfer devices as defined above. Examples of the computer readable medium include read-only memory, random access memory, CD-ROMs, flash memory cards, DVDs, magnetic tape, optical data storage devices, and carrier waves. The computer readable medium can also be distributed over network-coupled computer systems so that the computer readable code is stored and executed in a distributed fashion.

The disclosed methods and systems provide viewers of audiovisual works with contextual data relating to displayed items. As described above, viewers of audiovisual media are often interested in items displayed in audiovisual works, but are unable to identify the viewed items. The audiovisual work, however, usually provides no contextual data about the item.

As a result, the viewer is left without any convenient way of identifying and purchasing the item. Because the viewer is unable to identify the displayed item, she is left unsatisfied. Further, manufacturers and retailers of the displayed item likely lost, in the viewer, a customer interested in purchasing their product.

The disclosed methods and systems provide contextual data that allow viewers to identify such items. In particular, the disclosed methods display contextual data about items on the display unit of a listening device, such as a mobile electronic device, while the audiovisual work continues playing on a separate media playback device. By displaying the contextual data on a separate device, the viewer is able to quickly identify items without losing focus on or significantly hampering the work. The disclosed methods and systems may also provide elegant means for allowing viewers to purchase viewed items.

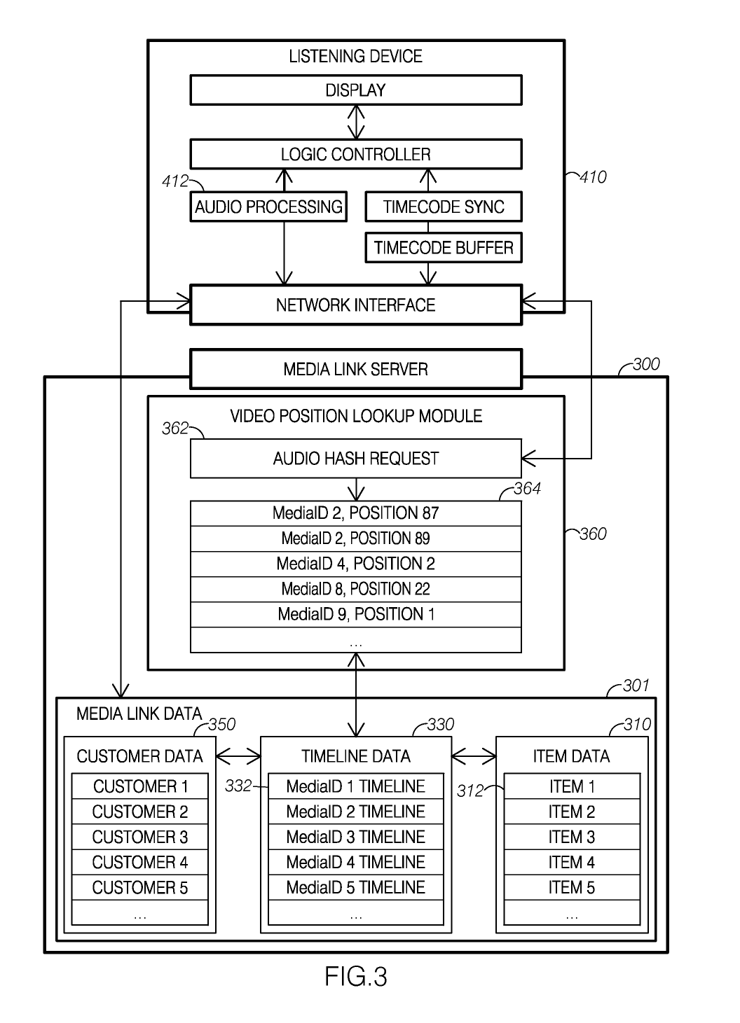

With reference to FIG. 3, some examples of the disclosed methods and systems may reference media link data stored on a media link server. FIG. 3 illustrates one way media link data may be organized; namely a media link dataset 301, hosted on a media link server 300. Other organization schemes are contemplated, and are equally within this disclosure.

Media link server 300 hosts data relating to audiovisual works and media linked items displayed therein. Media link server 300 is configured to cooperate with a paired mobile electronic device to provide contextual data about a media linked audiovisual work. The media link server may include any currently known or later developed server technology.

In many cases, the hosted data may be entered by producers, such as manufacturers or artisans, or retailers of displayed items. In some examples, the producers and retailers may work in concert with the administrator of media link server 300 to add contextual data about their products to media link dataset 301. By adding contextual data, producers and retailers allow viewers to readily identify their products. As a result, the producers and retailers are able to advertise and sell their products directly to the viewers as the viewers continue watching their desired audiovisual work.

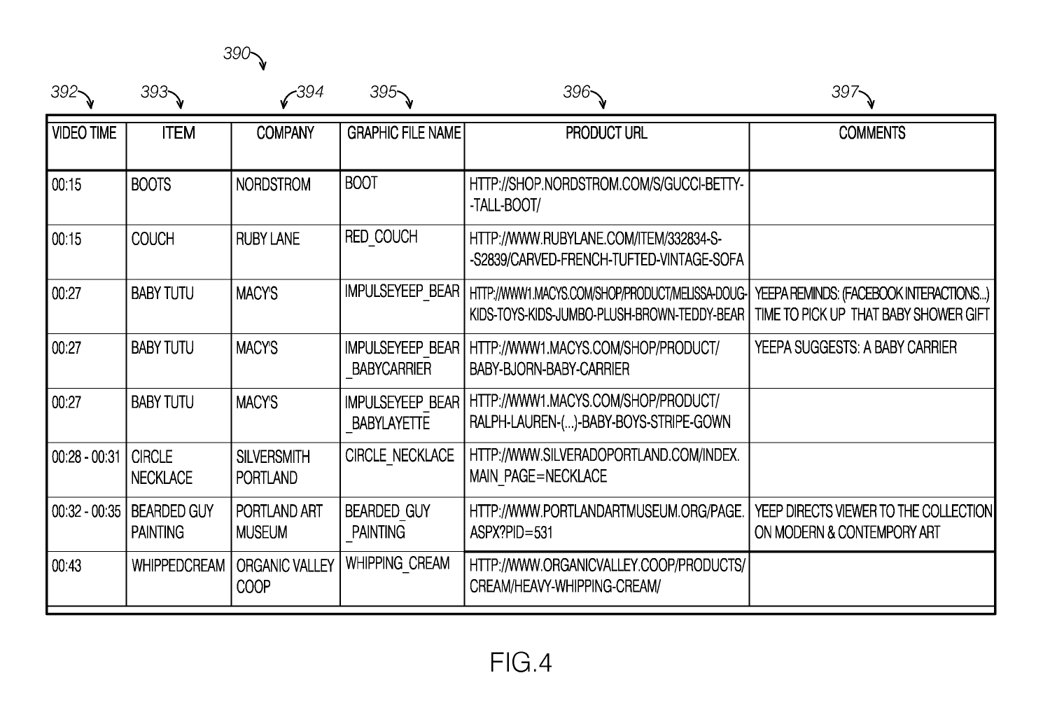

The contextual data associated with audiovisual works may be known in the art as “yeeps.” Each “yeep” may define a discrete entry identifying a particular item of interest in an audiovisual work. FIG. 4, for example, illustrates a table associated with a plurality of “yeeps.” Each row of data indicates data associated with a single “yeep.” As will be discussed in greater detail below, “yeeps” may be user generated through a tagging interface or entered and stored directly on the media link server, such as by producers and manufacturers collaborating with administrators of a media link server.

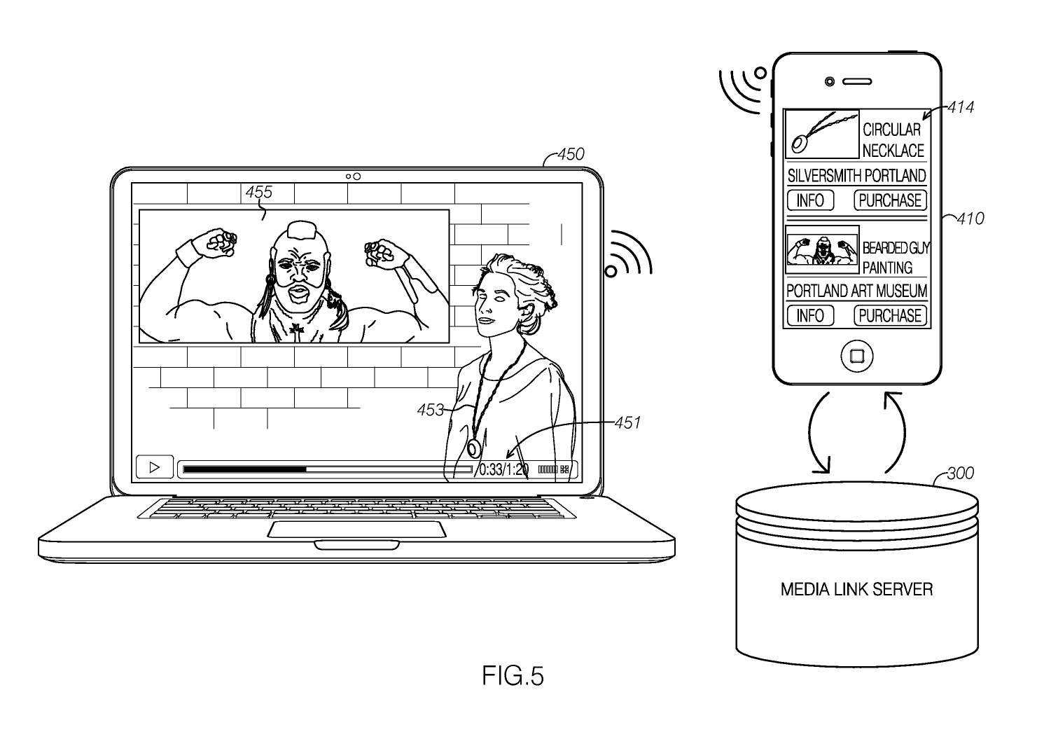

FIG. 5 illustrates an example whereby media link server 300 is in data communication with a mobile electronic device 410, allowing mobile electronic device 410 to receive contextual data about items displayed in an audiovisual work performed by a nearby media device 450. As FIG. 5 shows, mobile electronic device 410 is able to record a signal that identifies the audiovisual work and communicate the signal to media link server 300. Media link server 300, likewise, is configured to return item data associated with the audiovisual work, based on its processing of the recorded signal.

Upon determining the appropriate audiovisual work and current playback position, media link server 300 instructs mobile electronic device 410 to display information about each of the media linked items that should be displayed at the current playback position. Because data retrieved from media link server 300 is reliable, the user is conveniently provided with reliable identification information about displayed items as she watches the audiovisual work.

Media link dataset 301 is used in the present examples of methods for providing information relating to media linked items, such as the method described above. As FIG. 3 shows, media link dataset 301 includes an item dataset 310, a timeline dataset 330, and a customer dataset 350. Media link dataset 301 includes contextual data about audiovisual works and items displayed therein.

As FIG. 3 illustrates, item dataset 310 includes a plurality of item entries 312. Each item entry 312 is associated with an item shown in one or more audiovisual works. In some examples, the items specified by item entries 312 may be shown in multiple works; accordingly, item entries 312 may be linked with timeline dataset 330 to display the associated information in multiple audiovisual works.

In some examples, item data may be entered by producers or manufacturers of items displayed in audiovisual works. Additionally or alternatively, other users, such as those who have independently researched and identified displayed items, may enter item data.

In some examples, the contextual data about a particular item includes some or all of an item name, the name of the company that produces or sells the product, an internet address at which information about the company may be accessed, a graphical depiction of the logo of the company (or a reference to an externally hosted graphical logo), a graphical depiction of the product (or a reference to an externally hosted product graphic), an internet address at which information about the product may be accessed, additional comments relating to the selected product, or other information that may be useful to interested viewers. Additional comments may include, for example, suggestions of other companies or products that the viewer may be interested in based on her interest in the particular item.

Item data is not required to be associated with a particular merchant or retailer. Rather, it may be directed to a particular product, which may be available from a plurality of merchants. In some cases, the media link server may have stored a merchant associated with the item and directs all purchases to that stored merchant. In other examples, the media link server may associate a plurality of merchants with a product, and provide users with a list of merchants that they may select to purchase the product from.

For example, FIG. 5 illustrates a display of at least a portion of the contextual data associated with a first item 453. As FIG. 5 shows, the contextual data associated with first item 453 includes, at least, a graphical depiction of the product, an item name, a company name, and an internet address at which the viewer may find more information about first item 453 (displayed in the form of a user-selectable link labeled “INFO.”) FIG. 5 additionally shows item data relating to a second item 455.

As FIG. 3 shows, timeline dataset 330 includes one or more timeline entries 332. Each timeline entry 332 is associated with a particular audiovisual work, such as a single episode of a television show, a television advertisement, streaming internet media, or other audiovisual works.

In some examples, timeline data may be entered by producers or manufacturers of items displayed in audiovisual works. Additionally or alternatively, other users, such as those who have independently researched and identified displayed items, may enter timeline data.

As FIG. 3 illustrates, each timeline entry 332 may be linked with one or more item entries 312. By linking item entries 312 with a particular timeline entry 332, media link server 300 recognizes the media linked items that are associated with the identified audiovisual work.

Each timeline entry 332 includes timing data that directs the time at which the contextual data associated with a given item should be displayed. In some examples, the timing data associated with a linked item defines a time segment that reflects the time that the item is displayed on the media playback device. In some examples, however, the timing data may indicate some other specific time. In such examples, the mobile electronic device may be configured to display contextual data for a predetermined time period or until a user manually selects to hide displayed data, and the timeline data simply identifies a starting position at which the item data begins to be displayed.

As FIG. 3 shows, media link server 300 additionally includes a video position lookup module 360 configured to translate signals received from a mobile electronic device to a particular audiovisual work and position therein. As FIG. 5 shows, mobile electronic device 410 records a signal relating to an audiovisual work and communicates the signal to media link server 300. Using video position lookup module 360, media link server 300 can translate the signal to identify the audiovisual work and current playback position thereof. Upon identifying the particular audiovisual work, media link server 300 can identify appropriate timeline data and item data and provide timely contextual data for items displayed therein.

When media link server 300 receives a signal from a mobile electronic device, video position lookup module 360 processes the received signal through a hash function 362. Hash function 362 inputs the signal to calculate a unique hash value associated with that signal. As FIG. 3 shows, video position lookup module 360 includes a plurality of position identifiers 364, with each position identifier 364 being associated with a particular position within an audiovisual work.

Each position identifier 364 is associated with one or more stored hash values associated with the identified position. Accordingly, executing hash function 362 to calculate a hash value may produce one of the stored hash values associated with a particular position identifier 364.

When producing an equivalent hash value to one of the stored position identifiers 364, video position lookup module 360 resolves the signal to the appropriate position identifier 364 associated with the audiovisual work. Accordingly, video position lookup module 360 is able to recognize that the playback of the audiovisual work is currently located at the current playback position specified by the position identifier 364.

Given a resolved position identifier 364, media link server 300 can readily identify the timeline data and item data associated with the resolved position identifier 364. The associated timeline data and item data may include timing data and item data associated with the audiovisual work identified by the resolved position identifier 364.

In some examples, the positions identified by position identifiers may each be associated with ranges of a predetermined length; for example, each position may correlate to a five second segment of the associated audiovisual work. With such segmented position identifiers, each position identifier will often be associated with a large number of hash values. In some examples, the positions identified by the stored hash value may be a particular second within the runtime of the associated work. In other examples, the positions identified by the stored hash value may be spaced by greater or lesser increments.

In some examples, administrators may manually create a footprint of an audiovisual work by generating all (or a reasonable approximation thereof) potential hash values for an audiovisual work. By proactively creating a footprint, administrators may make work identification more effective and efficient.

In other examples, hash values associated with works may be generated on an ad-hoc basis during use. In such examples, users may “tag” items displayed in an audiovisual work. In such an example, the user may “tag” a portion of the work and then manually specify the identity and position of the tagged work. Media link server 300 will progressively start associating hash values with position identifiers based on an identification of the audiovisual work and current position entered by a tagging user.

While some examples include a hashing system to interpret raw audio, this disclosure additionally considers media link-adapted media devices that add item-identifying signals to playback. The item-identifying signals may define unique sub-audible signals, still detectable by mobile electronic devices' microphones. In some examples, each item's item data may define signal data that denotes the unique item identifying signal associated with the item. The media link-adapted media devices may output these signals during playback. Listening devices may be configured to listen for these item-identifying signals and communicate them to a media link server, rather than the raw audio.

By including discrete, identifiable signals, listening devices and media link servers may provide particularly accurate audiovisual work and item identification. In particular, listening devices and media link servers may be able to identify items directly (through the item-identifying signal), rather than relying on timeline data.

FIG. 4 illustrates a table 390 that shows timeline data and item data associated with the audiovisual work displayed in FIG. 5. A first column 392 illustrates timeline data specifying the portion of the audiovisual work in which contextual data about the associated item should be displayed. The other columns illustrate example item data.

Each entry in second column 393 specifies an item names for linked items. Each entry in third column 394 specifies the name of a company associated with the linked item. Each entry in fourth column 395 specifies a reference to an image file providing a graphical depiction of the product. Each entry in fifth column 396 specifies an internet address at which information about the product may be accessed. Each entry in sixth column 397 specifies additional comments relating to the selected product.

The table in FIG. 4 illustrates a way media link server 300 may use timeline data and item data to construct a timeline for connected audiovisual works. For example, the first entry, with a video time of 0:15, indicates that media link server 300 will instruct the mobile electronic device to display item data associated with “boots” when it receives a signal that indicates that the current playback position is approximately 15 seconds into the audiovisual work. Similarly, the three entries at 0:27 indicate that item data associated with all three associated items should be displayed approximately 27 seconds into the playback of the audiovisual work. The entries identified by item names “Circular necklace” and “Bearded Guy Painting” are each associated with a range, indicating that their associated item data should be displayed during the specified ranges. As FIG. 4 shows, ranged items can overlap in time; at overlapping times the item data associated with the items will be simultaneously displayed.

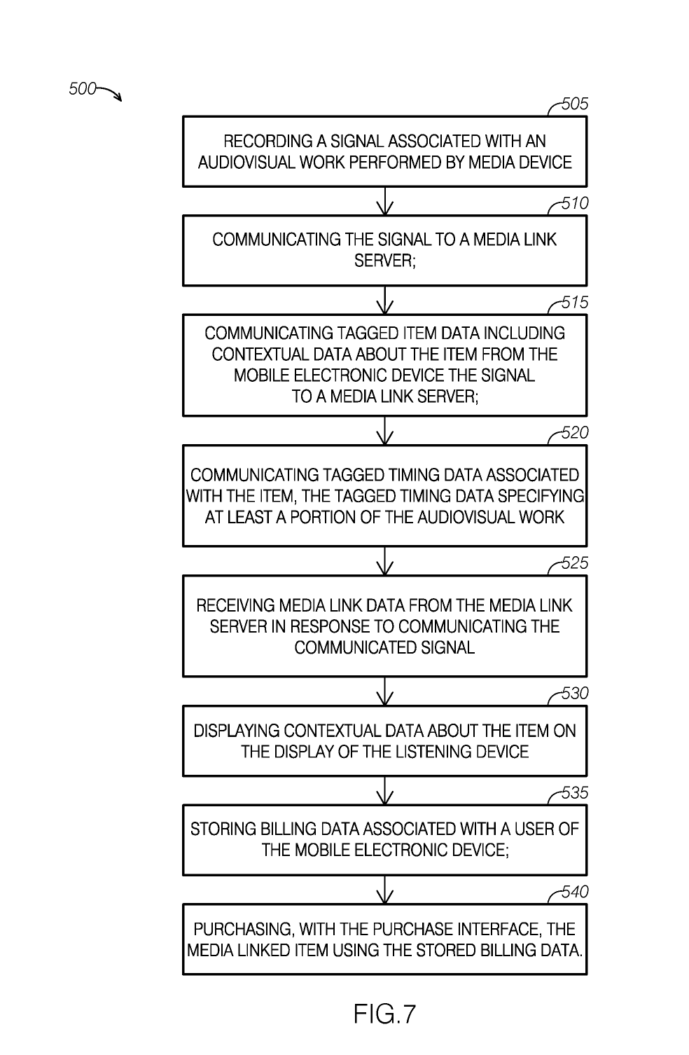

With reference to FIG. 7, an example of a method for providing information relating to items displayed in audiovisual works, method 500, will now be described. As FIG. 7 shows, method 500 includes recording a signal associated with an audiovisual work performed by media device step 505 and communicating the signal to a media link server at step 510. Method 500 further includes communicating tagged item data including contextual data about the item from the mobile electronic device the signal to a media link server at step 515 and communicating tagged timing data associated with the item, the tagged timing data specifying at least a portion of the audiovisual work at step 520. Method 500 includes receiving media link data from the media link server in response to communicating the communicated signal at step 525. The media link data includes item data associated with an item displayed during at least a portion of the audiovisual work. As shown in FIG. 7, method 500 includes displaying the at least a portion of item data about the item on the display of the listening device at step 530.

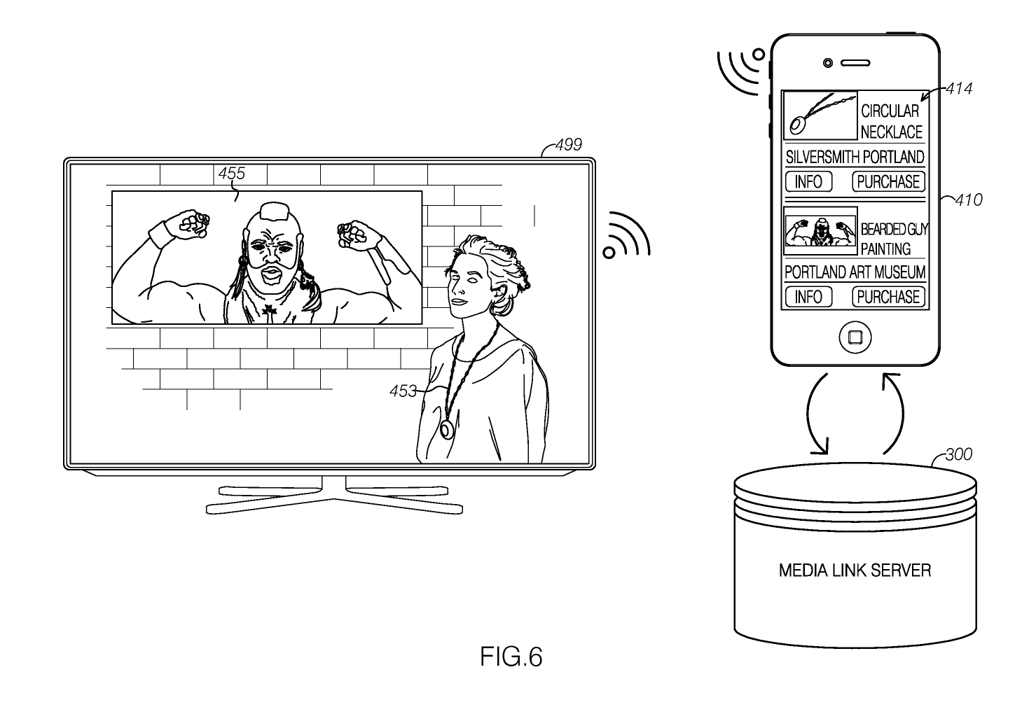

In some cases, a user may perform method 500 when viewing an audiovisual work. For example, a user may execute a mobile application that incorporate some or all of the steps of method 500 to identify items in an audiovisual work while the user watches the work. FIGS. 5 and 6 provide examples where mobile electronic device 410 is executing an application incorporating steps of method 500 to achieve this very function.

The mobile application may be in data communication with a media link server that hosts centrally-located, reliable contextual data about items displayed in the audiovisual work. This may allow the user to identify and purchase items displayed in audiovisual works using only her mobile electronic device. In some examples, the media link server hosts all data about all items associated with an implementation of the disclosed methods. In other examples, however,

FIG. 5 illustrates an example of a purchase interface that allows a user to purchase displayed items. Because users are able to purchase items directly from the mobile application, users are able to purchase items that interest them with little effort.

As FIG. 7 shows, a signal associated with an audiovisual work performed by a media device is recorded at step 505. The audiovisual work involved often displays an item for which a connected media link server hosts item data during at least a portion of its runtime.

In some examples, the signal is recorded with a listening device, such as with a mobile electronic device's microphone. In some examples, listening devices define desktop computers or other devices capable of audio or video recording.

The signal may define an audio signal linked with a video displayed on a media playback device. When recording the signal, the listening device encodes the audio signal in a computer readable format. For example, mobile electronic device 410 includes an audio processing system 412, which includes a sampler, audio preprocessor, and data packaging module. Mobile electronic device 410 may use audio processing system 412 to encode the signal prior to communicating it to a media link server. In some examples, signals may define images, which may be captured by a listening device's camera, or other signals associated with the audiovisual work.

In some examples, the signal may define an audio signal of a predetermined length. Making each signal uniform in length may assist hash function 362 in creating a discrete, manageable number of unique hashes while providing satisfactory media identification.

As FIG. 7 illustrates, the signal is communicated to a media link server at step 510. In some examples, a mobile electronic device uses its network interface to transmit the signal over a computer network to the media link server. In some examples, the media link server includes an internal database. The internal database may include data that is organized in a substantially similar format as media link server 300, shown in FIG. 3.

As FIG. 7 shows, tagged item data including contextual data about the item is communicated from the mobile electronic device to the media link server at step 515. Additionally, tagged timing data associated with the item is communicated to the media link server at step 520. The tagged timing data specifies a portion of the audiovisual work during which a mobile electronic device should display the tagged item data. In some examples, tagging of audiovisual works according to this disclosure, such as in steps 515 and 520, may be referred to in the art as “yeeping.”

In some examples, the tagged item data and tagged timing data are communicated to the media link server at the time of tagging. In other examples, however, the tagged item data and tagged timing data are stored locally and communicated to the media link server at a later time. Storing the tagged item and timing data may be useful when a user tags an audiovisual work with a mobile electronic device presently lacking a data connection, such as a mobile phone in “Airplane Mode.” In such an example, the mobile electronic device may store the tagged timing data and the tagged item data until a data connection is restored. In some examples, the mobile electronic device is configured to send the tagged item data and tagged timing data automatically upon a data connection being restored.

In some examples, the tagged timing data stores a static value based on the current playback position at the time of tagging an item in the audiovisual work. This may help ensure that tagged timing data refers to the correct time of an audiovisual work's playback when tagged data is communicated at a time after tagging, as described above.

The media link server is configured to store the tagged item and timing data and associate the tagged item and timing data with the audiovisual work. Because tagging users have already researched and identified displayed items, other users may capitalize on their work by receiving their tagged data from media link server 300. Providing a tagging interface may additionally provide an alternative interface for producers and retailers to tag items. This alternative interface may be more simple than working directly with the administrator of media link server 300.

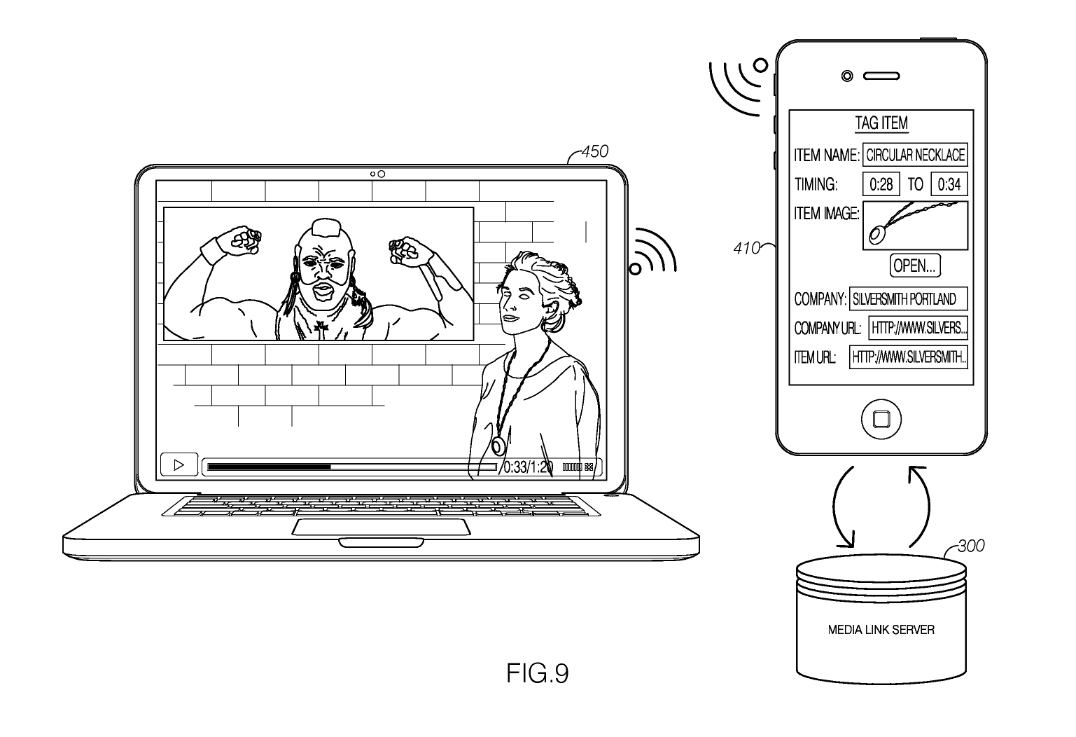

FIG. 9 illustrates an example of mobile electronic device 410 displaying a tagging interface. The displayed tagging interface allows a user to enter tagged data and submit the tagged data to the media link server. FIG. 9 illustrates a user tagging the “Circular Necklace” item depicted in FIGS. 5 and 6. As FIGS. 5 and 6 illustrate, the tagged item will be displayed on listening devices when the current playback position of a future viewing of the same audiovisual work is within the portion of the audiovisual work specified by the tagged timing data.

As FIG. 7 shows, media link data from the media link server is received on the listening device from the media link server in response to the listening device communicating the communicated signal at step 525. The received media link data includes item data associated with the item displayed in the audiovisual work and timing data associated with the item. The item data includes contextual data about the item, substantially similar to the item data of item entries 312. The timing data specifies at least a portion of the audiovisual work, substantially similar to the timeline data specified by timeline entries 332.

As described above, timeline entries 332, and particular playback positions specified therein, are often linked with a plurality of item entries. In some examples, displaying the item data on the display of the listening device includes displaying a listening device interface that displays each item entry that the associated timeline entry specifies should be displayed at the current playback position. FIGS. 5 and 6 illustrate a listening device interface 414 displaying item data associated with both first item 453 and second item 455. As shown in FIGS. 5 and 6, an item name and an item graphic associated with each item is displayed. In some examples, the displayed item data may include more or less information. For example, the listening device interface may display a minimal amount of information required to allow a user to identify an item and transact a purchase the item, which could include a graphical depiction of the item, an item name, and a purchase button.

As FIG. 7 shows, at least a portion of the item data on the display of the listening device is displayed when a current playback position of the audiovisual work is within the portion of the audiovisual work specified by the timing data at step 530. In some examples, the listening device receives item data from the media link server in response to the listening device sending the signal identifying the audiovisual work. The received item data is then displayed by the listening device on its display.

FIGS. 5 and 6 illustrate examples of mobile electronic device 410 displaying received data. For example, FIGS. 5 and 6 illustrate mobile electronic device 410 displaying, for each item associated with the current audiovisual work and current playback position thereof, an item name, the name of the company producing the product, a hyperlink pointing to the uniform resource locator associated with the company producing the product activated by selecting the company name, and a hyperlink pointing to the uniform resource locator associated with the product itself activated by selecting the “INFO” button.

In some examples, the item defines a product available for purchase from a merchant. In such examples, displaying the at least a portion of the item data on the display of the listening device includes displaying a purchase interface. The displayed purchase interface may allow a user of the mobile electronic device to purchase the item from the merchant.

When the item defines a product available for purchase from a merchant, method 500 allows users to store billing data associated with a user of the mobile electronic device at step 535 and purchase, with the purchase interface, the media linked item using the stored billing data at step 540. When purchasing the product, the transaction may be completed by any currently understood method of fulfilling online transactions. For example, payment may be fulfilled through a credit card payment, PayPal® or other electronic wallet services, or other common methods of electronic fulfillment methods.

Billing information, such as credit card information and account information associated with online fulfillment services, associated with each user may be stored in customer dataset 350. While method 500 allows users to store billing information, stored billing information is not required, and fulfilling a purchase order by manually entering billing information is considered by this disclosure.

Additional customer information, such as address information, user authentication data, and other user data, may also be stored in customer dataset 350.

By providing an immediate purchase interface and stored billing data, the disclosed methods may be particularly conducive to “impulse” purchases. Because items and purchase options are displayed almost immediately after the associated item is displayed onscreen and provide a quick, simple process for purchasing, the disclosed methods substantially allow users to purchase items nearly instantly after initial viewing and interest.

In some examples, all data required for transacting a purchase of all products, including item, merchant, billing, and shipping data, is all centrally stored on a media link server. In such an example, users are able to complete a transaction without ever browsing away from the listening device interface. Indeed, this may allow a user to purchase in one step by selecting to purchase a product, such as by selecting one of the “PURCHASE” buttons displayed on mobile electronic device 410 in FIG. 5.

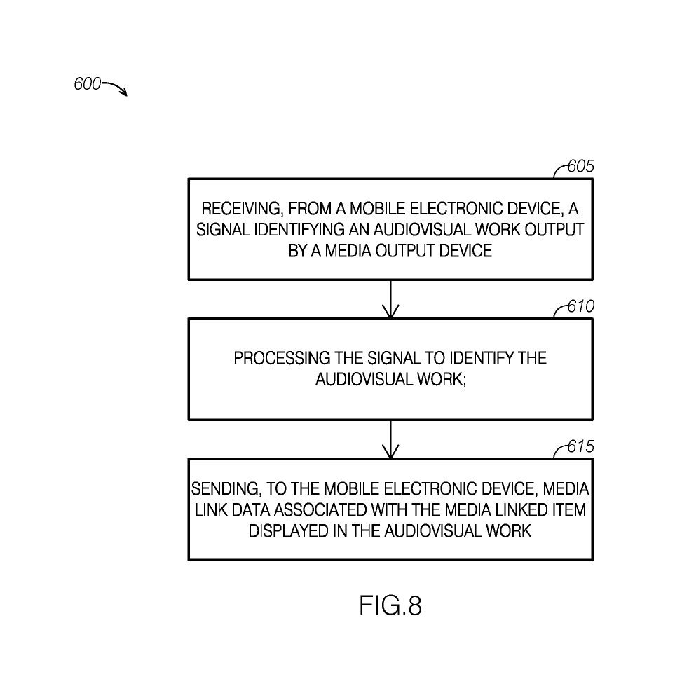

With reference to FIG. 8, an example of a method for providing information relating to objects displayed in visual media, method 600, will now be described. In some examples, one or more steps of method 600 are configured to be performed by a media link server cooperating with a listening device performing method 500. As FIG. 8 illustrates, method 600 includes receiving, from a mobile electronic device, a signal identifying an audiovisual work output by a media output device at step 605, processing the signal to identify the audiovisual work at step 610, and sending, to the mobile electronic device, media link data associated with the media linked item displayed in the audiovisual work at step 615.

As FIG. 8 shows, a signal sent from a mobile electronic device that identifies an audiovisual work output by a media output device is received at step 605. The received signal is substantially similar to the signal sent by the mobile electronic device at step 510. In some examples, the signal does not directly identify the audiovisual work; rather, the media link server must translate the signal to identify the work associated with the signal.

As FIG. 8 illustrates, the signal is processed to identify the audiovisual work at step 610. The media link server implements a video position lookup module, substantially similar to video position lookup module 360, to process the signal and identify the audiovisual work and current playback position thereof. The reader should reference the discussion of video position lookup module 360 above for details of the signal processing methodology performed at step 610.

As FIG. 8 illustrates, media link data associated with the media linked item displayed in the audiovisual work is sent to the mobile electronic device at step 615. Typically, the media link server translates the signal received at step 605 to determine the appropriate timeline entry and current playback position of the audiovisual work. Once the appropriate timeline entry and playback position are determined, the media link data returns item data and timing data associated with each item to be displayed at the current playback position. In some examples, the listening device is instructed, either by instructions executed thereon or by instructions sent by the media link server, to display the item data for each item to be displayed.

Viewing the data organization of FIG. 3, the table shown in FIG. 4, and the use case shown FIG. 5, the reader can see how method 500 and method 600 cooperate to display item data on a user's mobile device at an appropriate time.

As FIG. 5 shows, mobile electronic device 410 is recording a signal from media device 450, namely the audio played by media device 450 along with the displayed image. Mobile electronic device 410 communicates this recorded signal to media link server 300, which, in turn, receives and processes the data to retrieve the appropriate timeline data. Media link server 300, in particular, processes the signal using hash function 362 and resolves the signal to the appropriate position identifier 364. As FIG. 5 shows, the audiovisual work is currently pointed to a current playback position 451 of 0:33. The listening device records a signal output by the media device at or around this time and inputs the recorded signal into hash function 362. Hash function 362 resolves the input signal to the position identifier 364 associated with this time. With the correct position identifier 364, media link server 300 is able to retrieve the appropriate timeline data and item data.

FIG. 4 illustrates example timeline data that may have been retrieved by media link server 300 after properly identifying the audiovisual work. Of particular note are the entries identified by the item names “Circular Necklace” and “Bearded Guy Painting.” As the example timeline data shows, both the “Circular Necklace” item and the “Bearded Guy Painting” should be displayed at the 0:33 position in playback of the audiovisual work. Accordingly, media link server 300 sends item data and timing data to the mobile electronic device associated with these particular items. As FIG. 5 shows, mobile electronic device 410 receives the item data and displays it because the current playback time is consistent with the timing data defined by the audiovisual work's timeline entry.

In some examples, the listening device interface may be configured to display the contextual data received from a media link server for a set period of time. In such cases, the list of items displayed in the listening device interface may reflect the item data received within that set period of time. In some examples, however, the media link server may define discrete beginning and end times in which item data is to be displayed on the listening device. FIG. 4, for example, illustrates the “Circular Necklace” and

For example, the set time period may define a time period of 30 minutes; the list displayed in the listening device interface may reference all item data received in the last 30 minutes. In some examples, users may be able to use the listening device interface to define the set period of time as a user preference or setting. This disclosure notes that, depending on the user's preferences, the example shown in FIGS. 5 and 6 may not necessarily display a complete list of relevant item data.

In some examples, listening devices may be configured to receive item data about items displayed in audiovisual works after a delay. For example, a user may watch some or all of an audiovisual work when the listening device is not in data communication with the media link server, such as when in “Airplane Mode.” The listening device may be configured, in such examples, to receive some or all of the item data associated with the audiovisual work after restoring a data connection. In some examples, the listening device may receive such delayed item data after the listening device has been powered off for some or all of the duration of the audiovisual work, which may be particularly useful during movies or other events where mobile electronic devices are often turned off. These delayed items may be displayed in the listening interface for a predetermined amount of time, which may, in some cases, be defined by users in a user preferences or settings dialog.

FIG. 6 illustrates an additional or alternative example of how the disclosed methods may be deployed. The use shown in FIG. 6 is similar to the one shown in FIG. 5, but with a media device 499 defining a television. The example shown in FIG. 6 illustrates that many of the methods and steps described herein are configured to work with raw audiovisual data and are not required to communicate with media devices performing audiovisual works.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A method for providing information relating to an item displayed in an audiovisual work, the method comprising:
recording, with a listening device having a display, a signal associated with the audiovisual work performed by a media device, the item being displayed during at least a portion of the audiovisual work when performed by the media device;
communicating the signal to a media link server;
receiving, on the listening device, media link data from the media link server in response to communicating the communicated signal, the media link data including:
item data associated with the item displayed in the audiovisual work identified by the signal, the item data including contextual data about the item; and
timing data associated with the item, the timing data specifying at least a portion of the audiovisual work; and
displaying at least a portion of the item data on the display of the listening device when a current playback position of the audiovisual work is within the portion of the audiovisual work specified by the timing data.

2. The method of claim 1, wherein the item is displayed in the audiovisual work for the duration of the portion of the audiovisual work specified by the timing data.

3. The method of claim 1, wherein:
the signal defines an audio signal linked with a video displayed on a media playback device; and
recording the signal includes encoding the audio signal in a computer readable format.

4. The method of claim 3, wherein the signal defines a predetermined length.

5. The method of claim 1, wherein:
the item data defines first item data;
the media link data includes a timeline entry defining timeline data specific to the audiovisual work identified by signal;
the timeline entry is linked with one or more item entries, each item entry including item data relating to a single associated item; and
displaying the at least a portion of the item data on the display of the listening device includes displaying a listening device interface, the listening device interface displaying the item data of each item entry linked with the timeline entry.

6. The method of claim 5, wherein:
the item data includes:
an item name defining a textual name of the item; and
an item graphic defining a graphical depiction of the item; and
displaying the at least a portion of the item data on the display of the listening device includes simultaneously displaying the item name and item graphics of two or more of the item entries linked with the timeline entry.

7. The method of claim 1, wherein:
the item defines a product available for purchase from a merchant; and
displaying the at least a portion of the item data on the display of the listening device includes displaying a purchase interface that allows a user of the listening device to purchase the item from the merchant.

8. The method of claim 7, further comprising:
storing billing data associated with the user of the listening device; and
purchasing, with the purchase interface, the item using the stored billing data.

9. The method of claim 1, wherein:
the item data received from the media link server was entered in the media link server by a producer of the item; and
the timing data received from the media link server was entered in the media link server by the producer of the item.

10. The method of claim 1, wherein:
the item data includes a uniform resource locator pointing to an internet location hosting content specifically directed to the item; and
displaying the at least a portion of the item data on the display of the listening device includes displaying a hyperlinked pointing to the uniform resource locator.

11. The method of claim 1, further comprising:
communicating tagged item data including contextual data about the item from the listening device to the media link server; and
communicating tagged timing data associated with the item to the media link server, the tagged timing data specifying at least a portion of the audiovisual work; and
wherein the media link server is configured to:
store the tagged item data and the tagged timing data; and
associate the tagged item data and the tagged timing data with the audiovisual work.

12. A method for providing information relating to an item displayed in an audiovisual work, the method comprising:
receiving, from a listening device, a signal identifying an audiovisual work output by a media output device;
processing the signal to identify the audiovisual work;
sending, to the listening device, media link data associated with the item displayed in the audiovisual work, the media link data including:
item data associated with the item, the item data providing contextual data about the item; and
timing data associated with the item, the timing data specifying a segment of the audiovisual work in which the listening device is to be instructed to display the item data.

13. The method of claim 12, wherein the media link data includes a timeline entry including timeline data that identifies a plurality of playback positions in the audiovisual work.

14. The method claim 13, wherein processing the signal to identify the audiovisual work includes executing a hash function to calculate a unique hash value associated with the audiovisual work.

15. The method of claim 14, wherein the unique hash value associated with the audiovisual work calculated with the hash function identifies a particular position within the audiovisual work.

16. The method of claim 15, wherein processing the signal to identify the audiovisual work includes:
resolving, with the unique hash value, a position identifier associated with a portion of the audiovisual work; and
the media link data including sent to the listening device of:
item data associated with the position identifier; and
timing data associated with the position identifier.

17. The method of claim 13, wherein the timeline data includes timing data indicating that the listening device should display item data associated with the item at a current playback position of the audiovisual work.

18. The method of claim 17, wherein the timeline entry is linked to a plurality of item entries.

19. The method of claim 13, wherein the item data is linked to a plurality of timeline entries.

20. A system for providing information relating to an item displayed in audiovisual works, the system comprising:
a computer readable medium including processor executable instructions for:
receiving, with a listening device having a display, a signal associated with an audiovisual work performed by a media device, the item being displayed during at least a portion of the audiovisual work when performed by the media device;
communicating the signal to a media link server;
receiving, on the listening device, media link data from the media link server in response to communicating the communicated signal, the media link data including:
item data associated with the item displayed in the audiovisual work identified by the signal, the item data including contextual data about the item; and
timing data associated with the item, the timing data specifying at least a portion of the audiovisual work; and
displaying at least a portion of the item data on the display of the listening device when a current playback position of the audiovisual work is within the portion of the audiovisual work specified by the timing data.
